(19) United States
(12) Patent Application Publication
(10) Pub. No.: US 2014/0319840 A1
(43) Pub. Date: Oct. 30, 2014

(54) HYDROELECTRIC SYSTEM

(71) Applicant: Shun-Tsung Lu, Wufong Hsiang (TW)

(72) Inventor: Shun-Tsung Lu, Wufong Hsiang (TW)

(21) Appl. No.: 13/871,420

(22) Filed: Apr. 26, 2013

(51) Int. Cl. F03B 13/10

(52) U.S. Cl. CPC F03B 13/10
USPC 290/54

(57) ABSTRACT

A hydroelectric system is disclosed. The hydroelectric system may include a water reservoir, a water channel, a plurality of power generating units, a water pumping unit and a cover. In one embodiment, the water reservoir is on the ground and capable of receiving and storing water, such as a pond, lake, ocean or the like, and the water channel can be spiral and located underground. The power generating units are spacedly disposed in the water channel and when blades thereof are struck by the water flow, electricity is generated. The water pumping unit is connected to a bottom section of the water channel and the water reservoir respectively, and is able to pump the water in the water channel back to the water reservoir. In an exemplary embodiment, the power generating units can be disposed and operated in geographically flat areas.

### FIELD OF THE INVENTION

The present invention relates to a hydroelectric system, and more particularly to a hydroelectric system that is able to generate electrical power more efficiently and can be operated at geographically flat areas.

### BACKGROUND OF THE INVENTION

Developing non-polluting renewable energy has become an increasingly important topic worldwide due to various environmental, economical and even political concerns. Since natural energy is available throughout the world in various forms such as wind, solar, tidal and wave, it is more efficient and cost-effective to convert the natural energy to the non-polluting renewable energy.

A conventional hydroelectric system includes one or more rotatable water turbines, which are usually arranged in rivers, lakes, or reservoirs. Utilizing the potential differences of the water flow to drive water turbines to rotate, the water turbines can further drive one or more power generators in the hydroelectric system to generate electricity.

However, the conventional hydroelectric system is not a closed system when the water flow is harnessed to drive the water turbines, so external objects such as debris, stones and sand can be easily brought into the hydroelectric system to block and damage the blades of the water turbines to adversely affect the efficiency of power generation. Also, extra maintenance costs may be needed to repair the damaged blades of the water turbines.

Furthermore, the water turbines in current hydroelectric systems are usually disposed vertically. Namely, the water turbines are linearly disposed from a higher to a lower place, so the height between the higher and lower places is fixed. Also, each water turbine occupies certain spaces, so the number of water turbines is limited as well as the power generation efficiency. Therefore, there remains a need for a new and improved hydroelectric system to overcome the problems stated above.

### SUMMARY OF THE INVENTION

It is an objective of the present invention to provide a hydroelectric system in which the water channel is covered so the power generating units therein are less likely to be blocked or damaged by external objects to enhance the power generating efficiency.

It is another objective of the present invention to provide a hydroelectric system in which the water channel is arranged in a spiral manner so the power generating units can be disposed therein to form a “multi-layered” power generating module where the number of the power generating units may not be limited to further enhance the power generating efficiency.

It is a further objective of the present invention to provide a water turbine having detachable blades designed for generating high torque to enhance power generating efficiency.

It is still a further objective of the present invention to provide a hydroelectric system in which the power generating units can be disposed in a geographically flat area.

In one aspect, a hydroelectric system may include a water reservoir, a water channel, a plurality of power generating units, a water pumping unit and a cover. In one embodiment, the water reservoir is on the ground and capable of receiving and storing water, such as a pond, lake, ocean and the like. The water channel can be spiral and located underground, and the position of the water channel is lower than the water reservoir. In another embodiment, the water channel has a top section and a bottom section, and the top section of the water channel is connected to and communicates with the water reservoir.

In a further embodiment, each power generating unit may include a power generator and a plurality of blades secured at a base of the power generating unit. The power generator has a main body, a first gear, a second gear, a shaft and a turbine. Each main body is connected to the first gear through a gear shaft, and engages with corresponding second gear. Each shaft passes through corresponding second gear, turbine and a conjugating hole of the blades. When the blades are struck by the water flow, the shaft, second gear, first gear would rotate accordingly to enable the main body to generate electricity.

In still a further embodiment, the blades are specially designed to achieve higher power generating efficiency. In particular, the blade is like a “hook” that can be divided into two curved sections including a first section and a second section. The curvature of the two sections is different so that the blade is allowed to retain more water when being struck by the water flow to increase the rotating speed of the blades and shaft to further enhance the power generating efficiency of the power generating unit. It is noted that the blades may be detached from the base according to the user's preference to adjust the performance of the power generating unit.

In an exemplary embodiment, a box is disposed underground and the box is a hollow triangular prism. The water channel is arranged along inner walls of the box and the water channel can be spiral as well. In still an exemplary embodiment, an underground box is a hollow rectangular prism and a spiral water channels is arranged along inner walls of the hollow rectangular prism.

In other embodiments, a plurality of power generating units can be disposed at a river, wherein water flow of the river can be used to strike multiple power generating units to generate electricity. It is worth noted that the water in the river is a natural resource and under normal condition, the water supply is continuous so no water pump is needed, which can save the costs of power generation as well as protect the environment. It is also noted that the river may have a branch and the power generating units can be disposed therein, and the water flows back to the river at the end of the branch. It is advantageous to dispose the power generating units in the branch because the power generating units may block the natural flow of the river if there are too many of them disposed therein.

### BRIEF DESCRIPTION OF THE DRAWINGS

FIG. 1 illustrates a sectional view of one embodiment in the present invention.

FIG. 2 illustrates the embodiment (of FIG. 1) in use in the present invention.

FIG. 3 illustrates a schematic view of the power generating units in the present invention.

FIGS. 3a to 3c illustrate an exemplary embodiment of the power generating unit in the present invention.

FIGS. 3d and 3e illustrate two blades with different angles in the present invention.

FIGS. 3f and 3g illustrate the experimental results of the blades with different angles and corresponding torques generated therefrom.

FIGS. 3h and 3i illustrate the experimental results of the blades with different width and corresponding torques generated therefrom.

FIGS. 3j and 3k illustrate the experimental results of different number of the blades and corresponding torques generated therefrom.

FIG. 4 illustrates another embodiment including the water channel in the triangular prism in the present invention.

FIG. 5 illustrates a further embodiment including the water channel in the rectangular prism in the present invention.

FIG. 6 illustrates a schematic view of an exemplary embodiment in the present invention.

FIG. 7 illustrates a schematic view of another exemplary embodiment in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

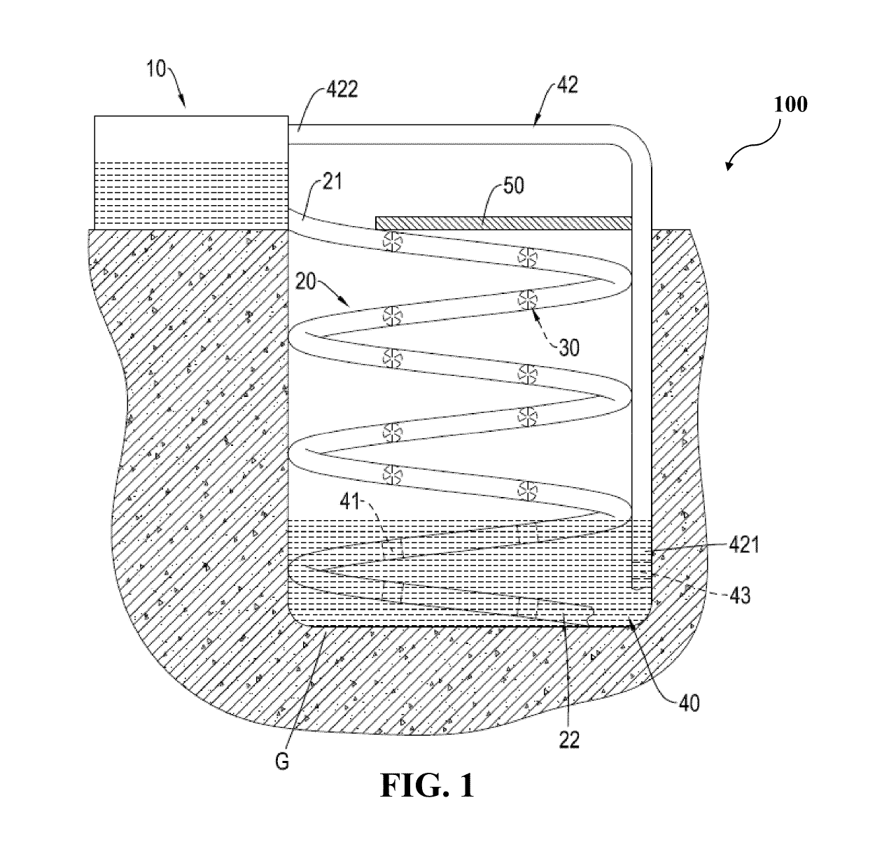

Referring to FIG. 1, a hydroelectric system 100 may include a water reservoir (10), a water channel (20), a plurality of power generating units (30), a water pumping unit (40) and a cover (50). In one embodiment, the water reservoir (10) is on the ground and capable of receiving and storing water, such as a pond, lake, ocean and the like. The water channel (20) can be spiral and located underground (G), and the position of the water channel (20) is lower than the water reservoir. The water channel (20) has a top section (21) and a bottom section (22), and the top section (21) of the water channel is connected to and communicates with the water reservoir (10), so the water can flow down with potential energy to drive the power generating units (30).

As shown in FIGS. 1 to 3, a plurality of power generating units (30) are spacedly disposed in the water channel (20). Each power generating unit (30) may include a power generator (31) and a plurality of blades (32). The power generator (31) has a main body (311), a first gear (312), a second gear (313), a shaft (314) and a turbine (315). Each main body (311) is connected to the first gear (312) through a gear shaft, and engages with corresponding second gear (313). Each shaft (314) passes through corresponding second gear (313), turbine (315) and a conjugating hole of the blades (32). When the blades (32) are struck by the water flow, the shaft (314), second gear (313), first gear (312) would rotate accordingly, so the main body (311) can generate electricity. It is noted that the power generating units (30) are disposed in the spiral water channel (20) to create a “multi-layered” power generation module in which the number of the power generating units (30) can be significantly increased to enhance the power generating efficiency.

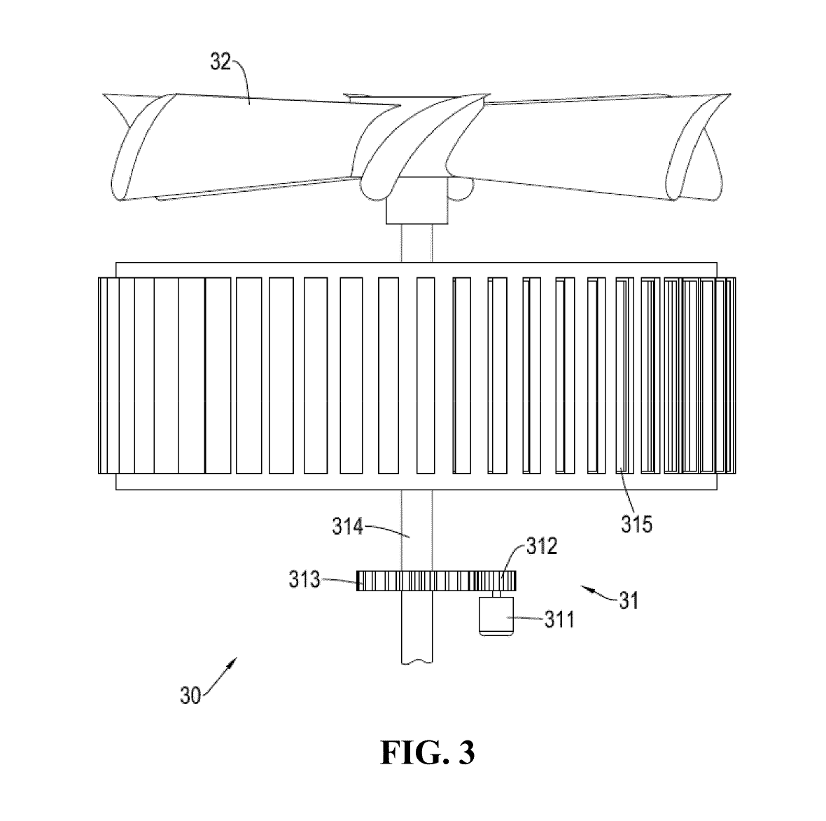

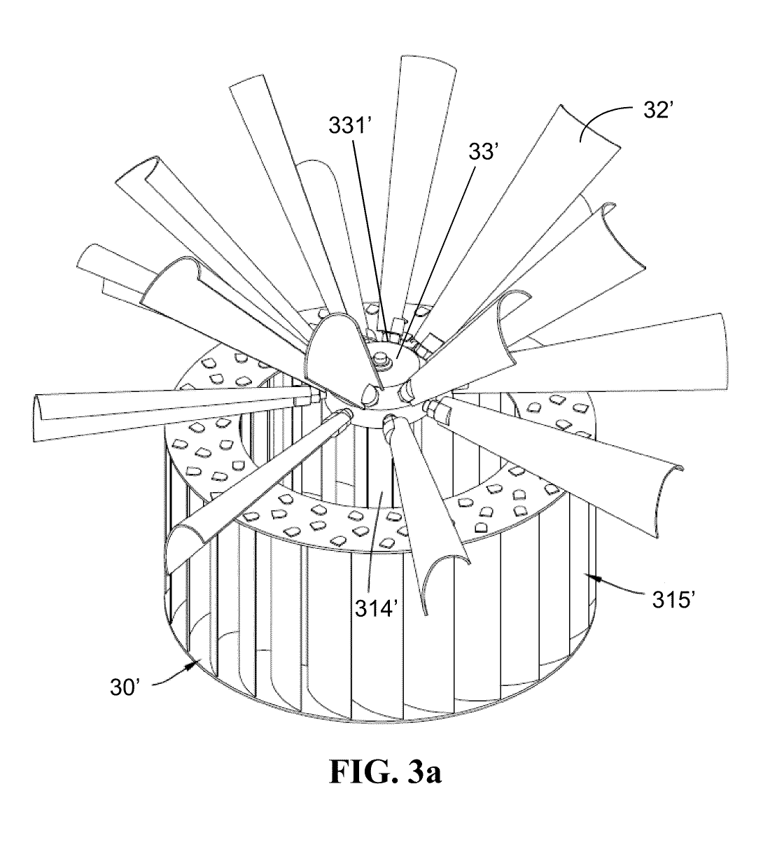

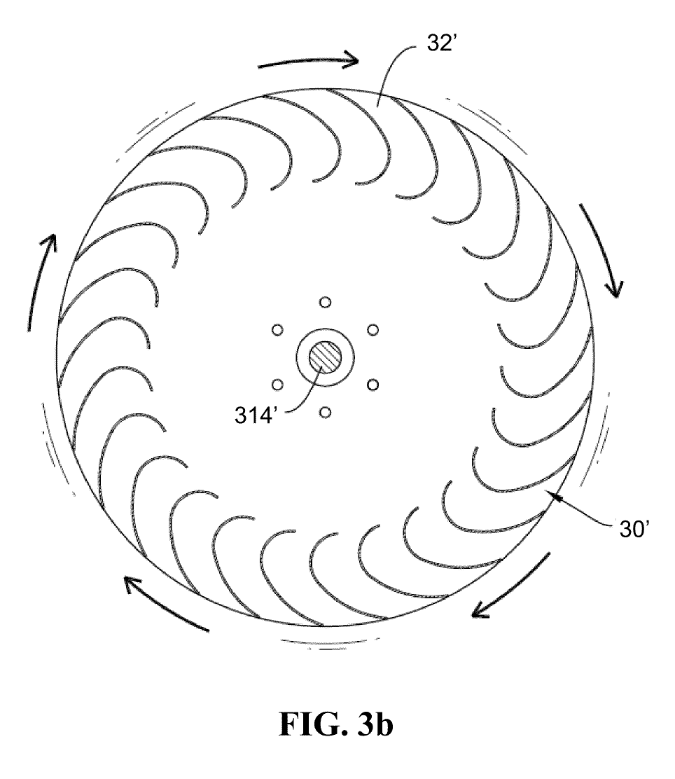

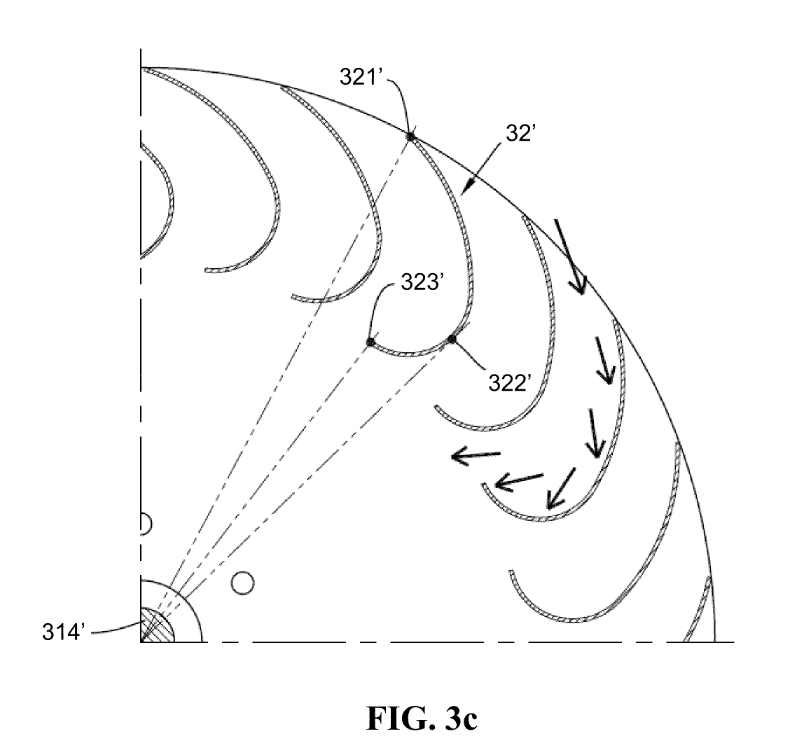

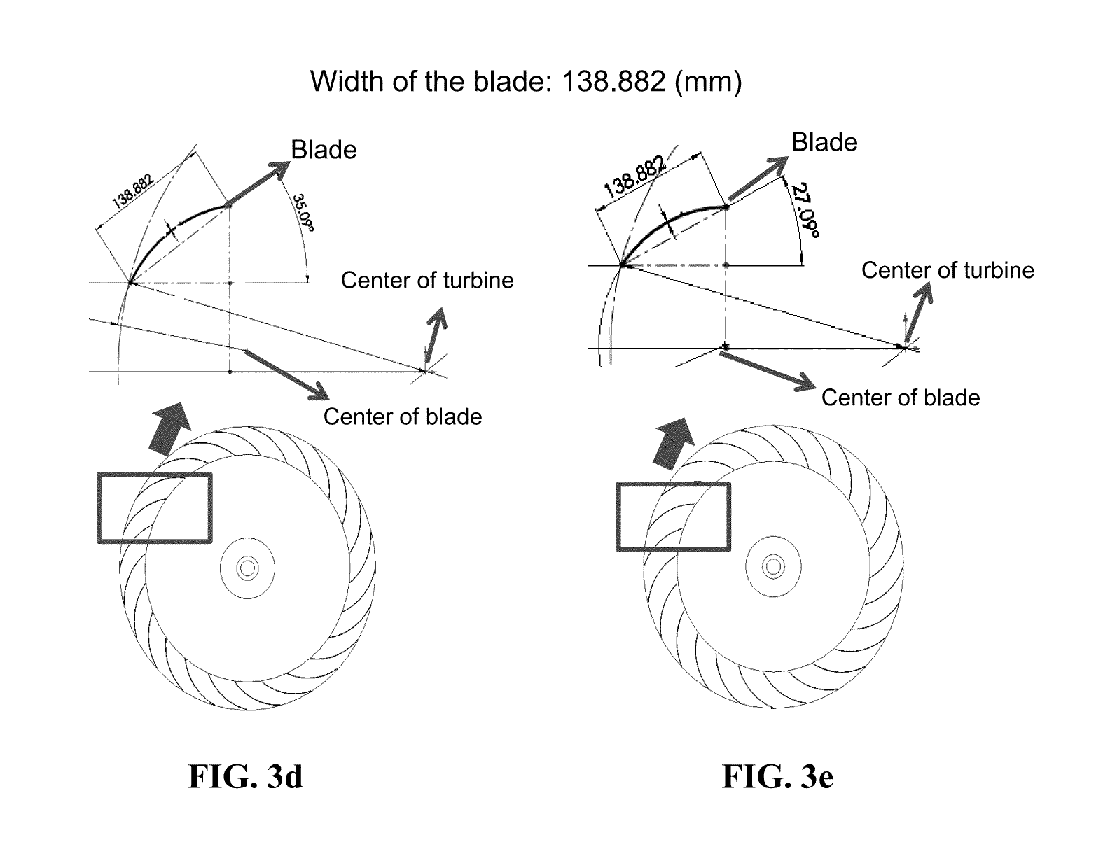

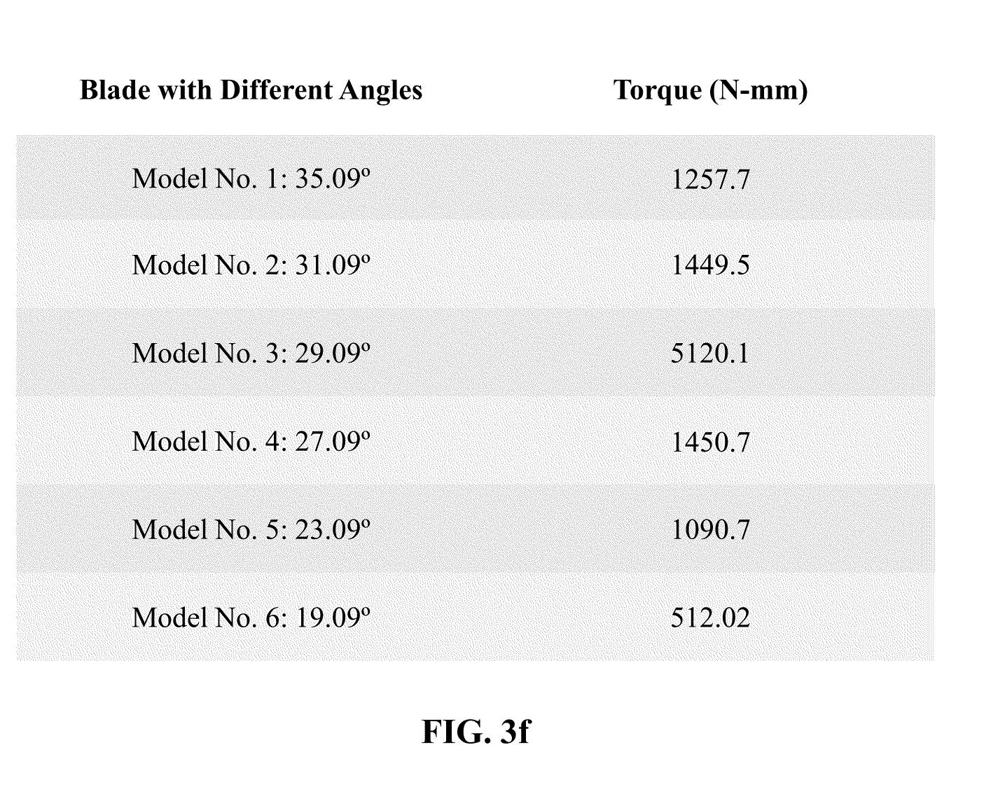

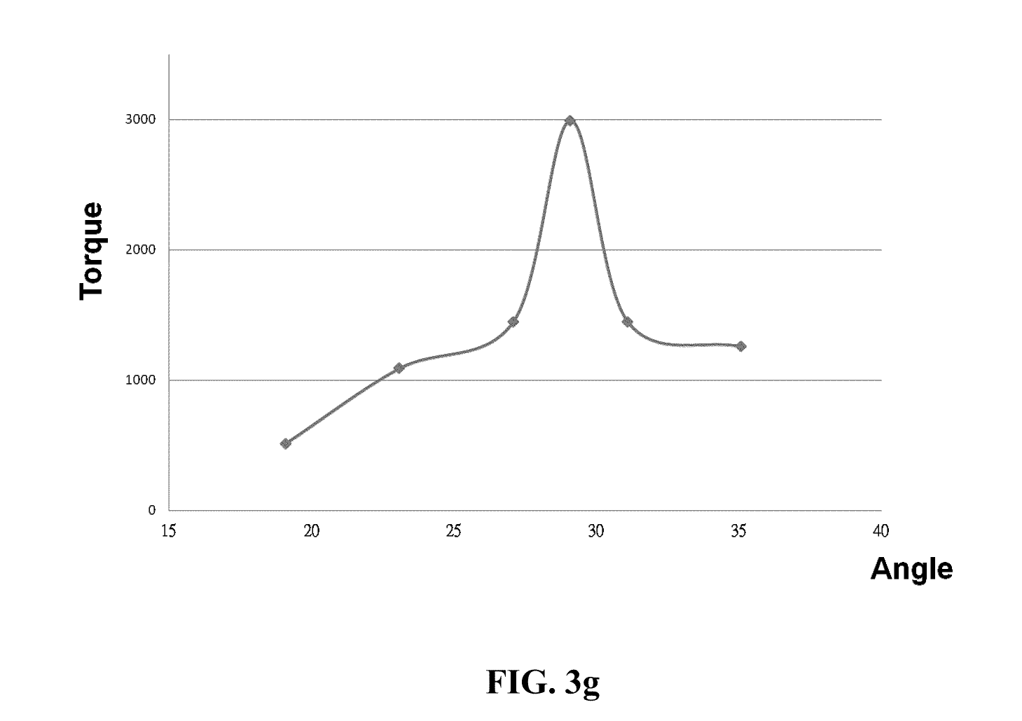

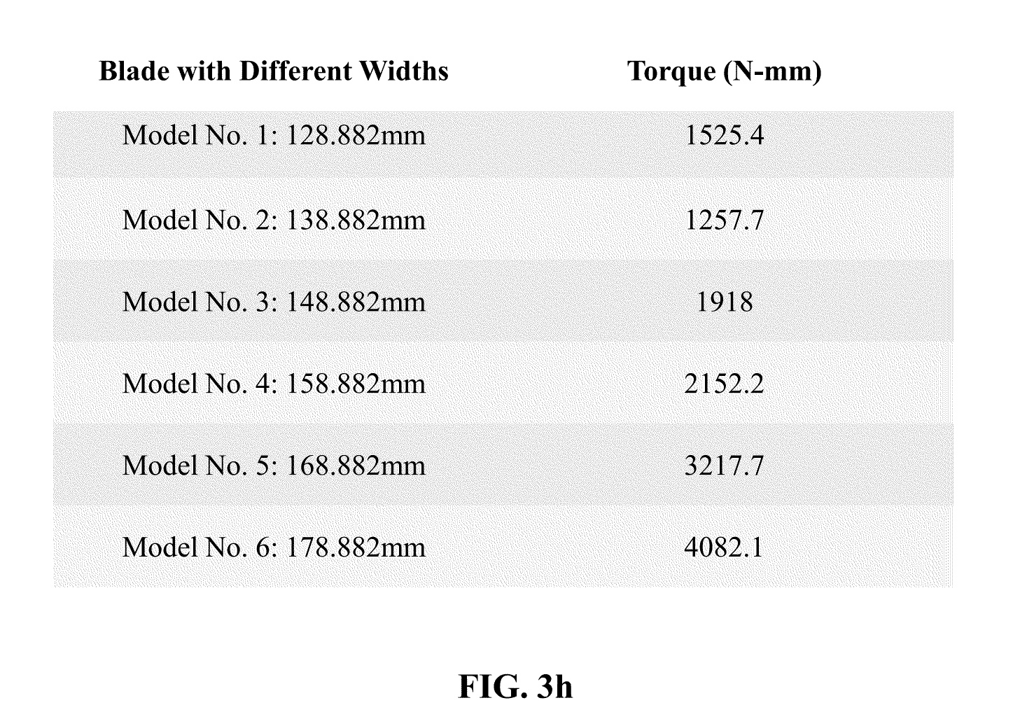

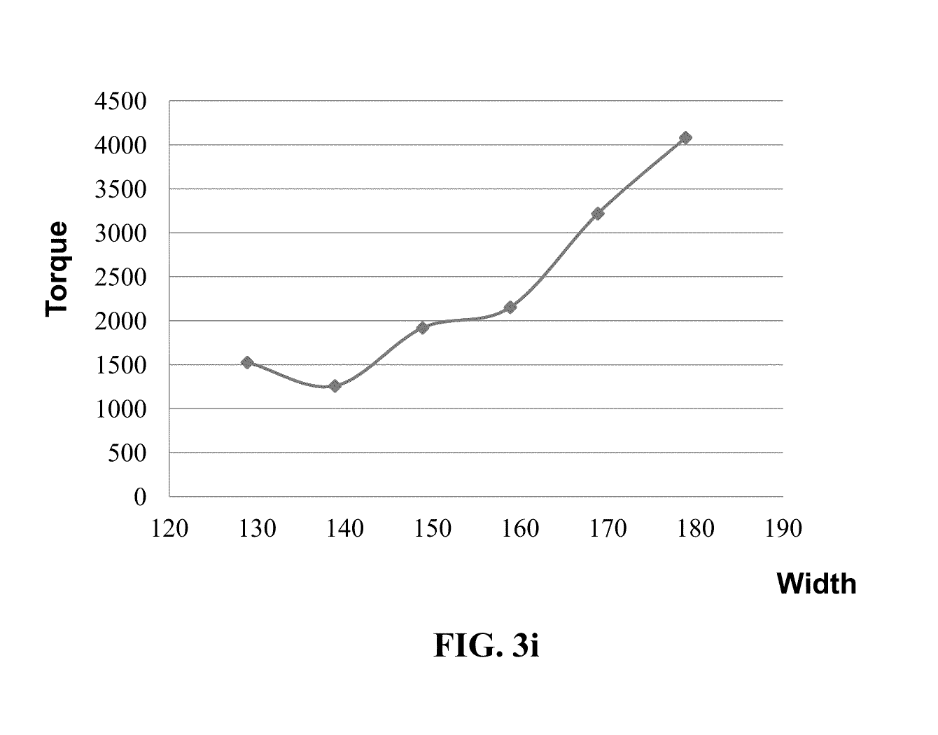

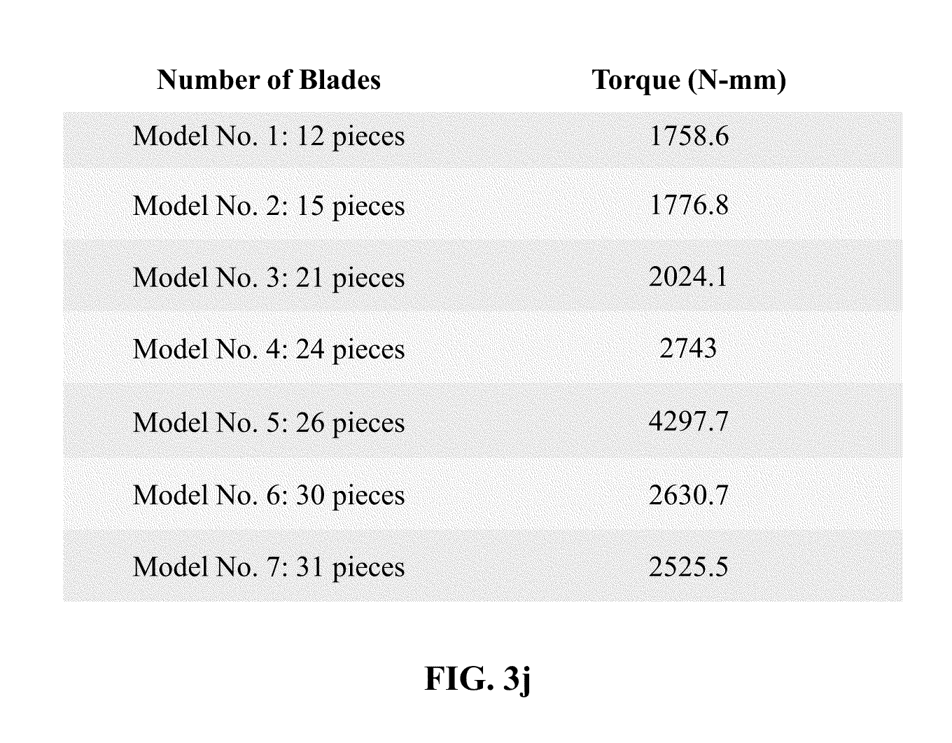

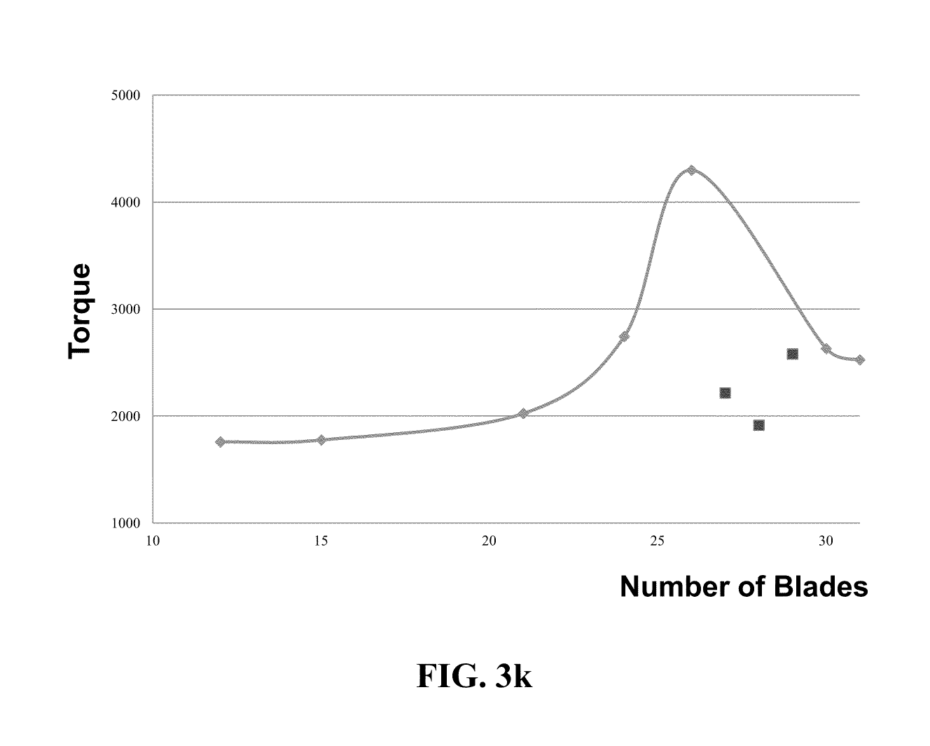

In an exemplary embodiment illustrated in FIG. 3a, a power generating unit (30′) may have a plurality of blades (32′), a shaft (314′), a turbine (315′) and the gears such as the power generating unit (30) in FIG. 3. The blades (32′) are secured at a base (33′) with a plurality of securing holes (331′) used to secure the blades (32′) at the base (33′). It is noted that the blades (32′) are detachable from the base (33′), so the blades (32′) can be added or removed according to the user's preference.

Like conventional power generating units, the blades (32′) would drive the shaft (314′) gears (not shown) to rotate to generate electricity accordingly. However, unlike conventional blades, the blades (32′) are specially designed to achieve higher power generating efficiency. In particular, the blade (32′) is like a “hook” that can be divided into two curved sections including a first section (321′-322′) and a second section (322′-323′), as shown in FIGS. 3b and 3c. The blade (32′) with the “hook” structure is allowed to retain more water when being struck by the water flow to increase the torque of the blades (32′) and shaft (314′) to further enhance the power generating efficiency of the power generating unit (30′).

The toque of the blade may be affected by the factors including the thickness of the blade, the curvature (angle) of the blade, and the number of the blade. FIGS. 3d and 3e illustrate two different blades with identical thickness (138.882 mm) but different angles, which is measured at the first section (321′-322′) of the blade (32′). The angle of the blade in FIG. 3d is 35.09°, while it is 27.09° in FIG. 3e. As stated above, the power generating efficiency can be enhanced if the torque of the blade increases. As shown in FIGS. 3f and 3g, the torque of the blade (32′) may not linearly increase as the angle of the first section (321′-322′) increases, and the maximum torque occurs when the angle of the first section (321′-322′) of the blade (32′) is 29.09°.

As to the thickness of the blade (32′), the torque of the blade (32′) increases somewhat linearly as the thickness of the blade (32′) increases, and the maximum torque occurs when the thickness of the blade (32′) is 178.882, as shown in FIGS. 3h and 3i. It is noted that when conducting the experiment with different thickness of the blade, the angle (of the first section) is set at 29.09°.

As discussed above, the blades (32′) are detachable from the base (33′), so the number of the blades can be adjusted according to the user's preference. As shown in FIGS. 3j and 3k, the torque reaches the maximum value of 4297.7 (N−mm) when the number of blade is twenty-six (26), and the torque decreases even though the number of blade increases thereafter. According to the above experimental results, the user can adjust the factors that may affect the performance of the power generating unit (30) to enhance power generating efficiency.

Referring again to FIG. 1, the water pumping unit (40) is connected to the bottom section (22) of the water channel (20) and the water reservoir (10) respectively, and is able to pump the water in the water channel (20) back to the water reservoir (10). In a further embodiment, the water pumping unit (40) may have a plurality of water pumps (41), a reflex pipe (42) and a reflux pump (43). The water pumps (41) are spacedly disposed in the water channel (20) and below the power generating units (30). The reflex pipe (42) has an inlet end (421) and an outlet end (422), and the inlet end (421) is close to the bottom section (22) of the water channel (20), while the outlet end (422) is connected to the water reservoir (10). The reflux pipe (42) and the reflux pump (43) are connected to the water pumps (41). Furthermore, the cover (50) can be disposed on top of the water channel (20).

It is noted that in the present invention, “close to” means “abutment” or “adjacent.” Namely, the inlet end (421) can abut against the bottom section (22) of the water channel (20), or the inlet end (421) can connect and communicate with the bottom section (22) of the water channel (20) to achieve the same goal of pumping the water from the water channel (20) to the water reservoir (10).

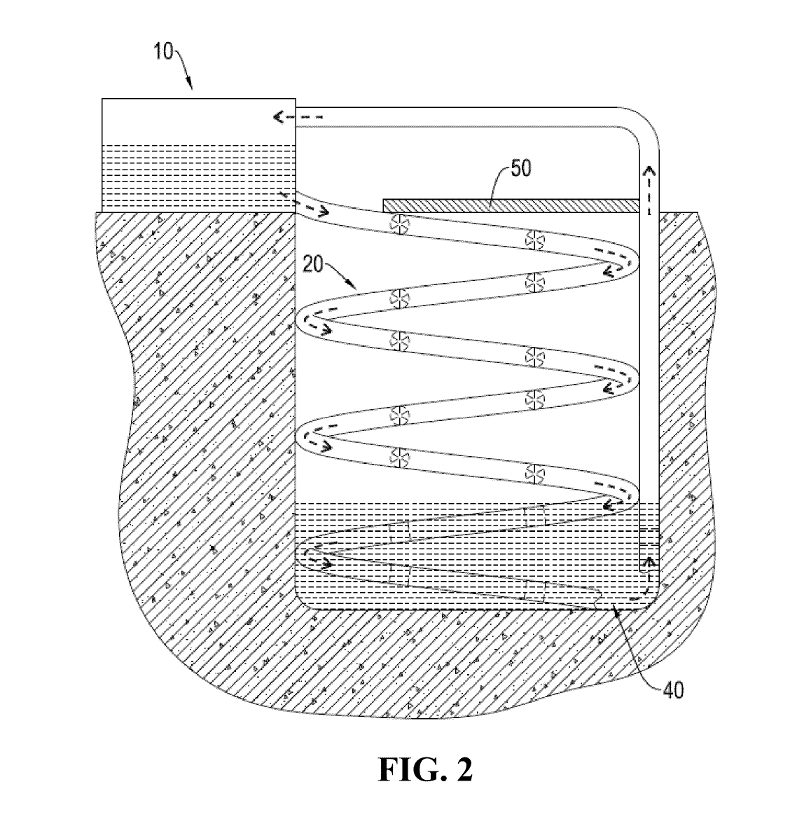

Referring to FIG. 2 for an exemplary embodiment, water from the water reservoir (10) flows into the water channel (20) and strikes the power generating units (30) therein to generate electricity. When the water flows to the bottom section (22) of the water channel (20), the water pumps (41) would pump the water back to the water reservoir (10) through the reflux pipe (42). Some water would flow to underground and be stored there, and the reflux pump (43) would also pump the underground water to the water reservoir (10) through the reflux pipe (42).

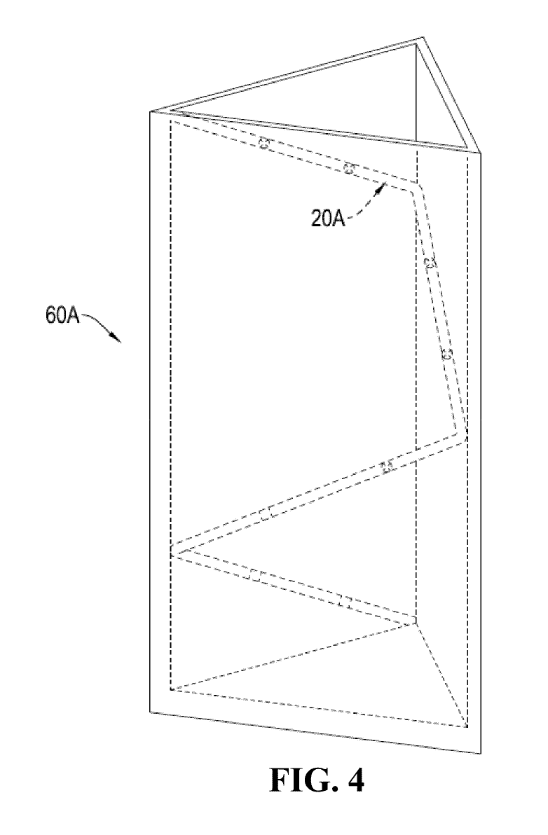

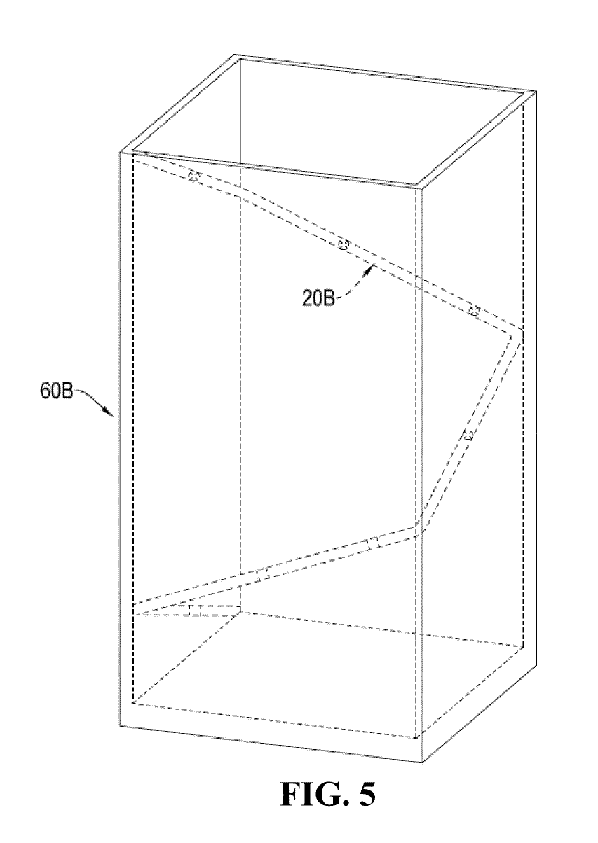

Referring to FIG. 4 for another exemplary embodiment which is similar to the above embodiment in FIG. 2, a box (60A) is disposed underground and the box is a hollow triangular prism. A water channel (20A) is arranged along inner walls of the box (60A), and the water channel (20A) can be spiral as well. Likewise, an underground box (60B) in FIG. 5 is a hollow rectangular prism, and a spiral water channel (20B) is arranged along inner walls thereof. Like in the embodiment in FIG. 2, water from the water reservoir (10) flows into the water channel (20A, 20B) and strikes the power generating units therein to generate electricity, and the water would be pumped back to the reservoir (10) by the water pumping unit (40).

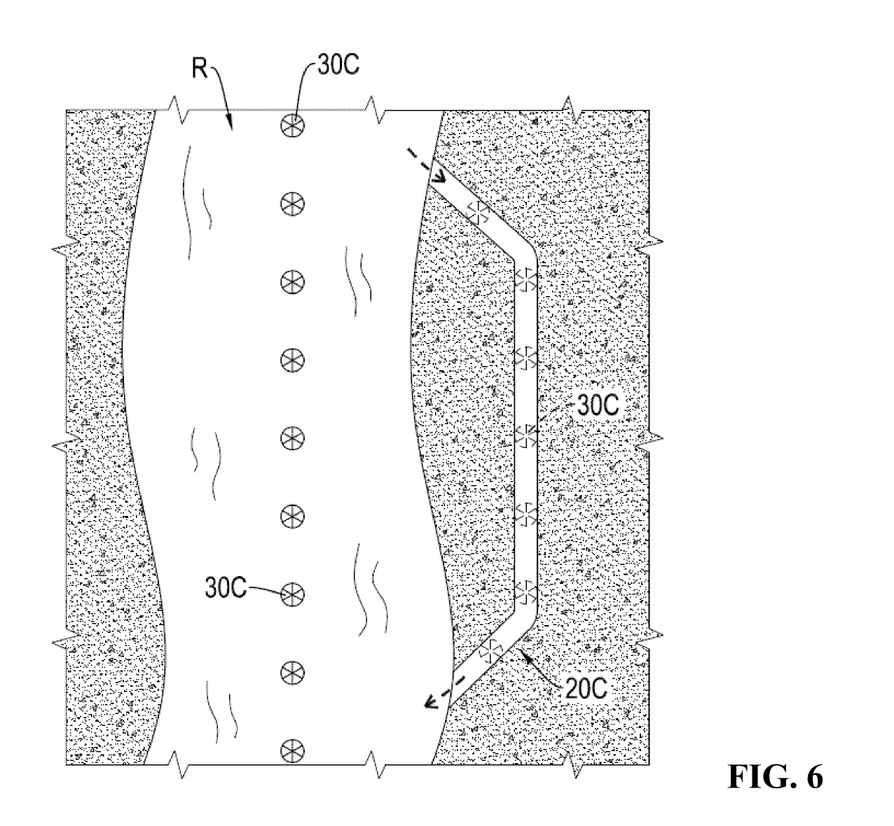

In a further embodiment as shown in FIG. 6, a plurality of power generating units (30C) can be disposed at a river R, wherein water flow of the river R can be used to strike multiple power generating units (30C) to generate electricity. It is worth noted that the water in the river is a natural resource and under normal condition, the water supply is continuous so no water pump is needed, which can significantly save the costs of power generation as well as protect the environment. It is also noted that the river R may have a branch (20C) and the power generating units (30C) can be disposed therein, and the water flows back to the river R at the end of the branch (20C). It is advantageous to dispose the power generating units (30C) in the branch (20C) because the power generating units (30C) may block the natural flow of the river R if there are too many of them disposed therein.

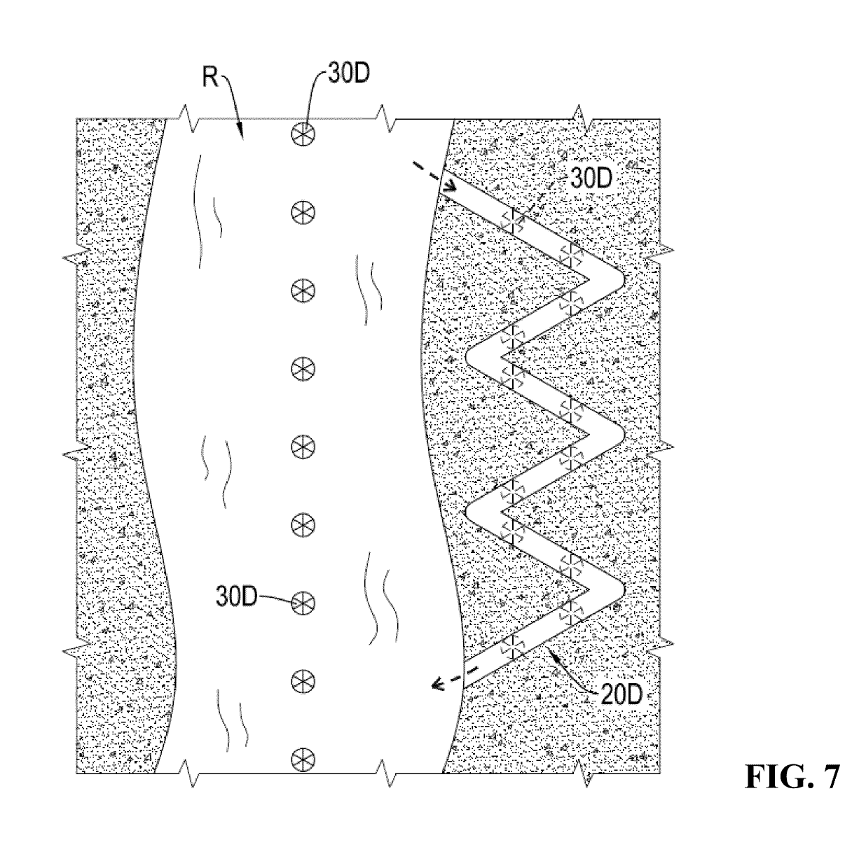

In still a further embodiment as shown in FIG. 7, a plurality of power generating units (30D) can be disposed at the river R, wherein water flow of the river R can be used to strike multiple power generating units (30D) to generate electricity. Like the embodiment in FIG. 6, the river R has a branch (20D) which is spiral in the present embodiment. Unlike branch (20C), branch (20D) is spiral and the power generating units (30D) can be disposed therein, and the water may flow faster in the spiral branch (20D) to have stronger strike on the power generating units (30D) to enhance the efficiency of power generation. In summary, in the embodiments illustrated in FIGS. 1 to 5, the water flows from a higher place to a lower place and the potential energy of the water is converted to the electrical power generated by the power generating units, however, in the embodiments illustrated in FIGS. 6 and 7, the power generating units can be disposed in the river, which is usually located in a geographically flat area. In other words, unlike conventional hydroelectric systems, the electrical power generated from the hydroelectric system in the present invention does not merely rely on the conversion of potential energy, so the hydroelectric system can be arranged and disposed in more areas even though they are geographically flat. Furthermore, the hydroelectric system in the present invention can be more widely used in various geographical areas.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A hydroelectric system comprising:
a water reservoir on the ground;
a multi-layered power generating module comprising:
a spiral water channel located underground, wherein position of the water channel is lower than the water reservoir, and the water channel has a top section and a bottom section, the top section of the water channel connected to and communicating with the water reservoir; and
a plurality of power generating units spacedly disposed in the spiral water channel, wherein each power generating unit has a power generator and a plurality of blades, and the blades are rotatable and secured at a base of said power generator;
a water pumping unit connected to the bottom section of the water channel and the water reservoir respectively to pump the water in the water channel back to the water reservoir; and
a cover disposed on top of the water channel.

2. The hydroelectric system of claim 1, wherein the water pumping unit includes a plurality of water pumps, a reflex pipe and a reflux pump; the water pumps spacedly disposed in the water channel and below the power generating units; the reflex pipe having an inlet end and an outlet end, and the inlet end thereof close to the bottom section of the water channel, while the outlet end connected to the water reservoir; and the reflux pipe and the reflux pump connected to the water pumps.

3. The hydroelectric system of claim 2, wherein the inlet end is adjacent to the bottom section of the water channel.

4. The hydroelectric system of claim 2, wherein the inlet end is connected to and communicates with the bottom section of the water channel.

5. The hydroelectric system of claim 1, further comprising a box located underground and the water channel is disposed at inner walls of the box.

6. The hydroelectric system of claim 5, wherein the box is a hollow triangular prism.

7. The hydroelectric system of claim 5, wherein the box is a hollow rectangular prism.

8. The hydroelectric system of claim 1, wherein the power generator includes a main body, a first gear, a second gear, a shaft and a turbine; each main body connected to the first gear through a gear shaft and engaging with corresponding second gear; each shaft passing through corresponding second gear, turbine and a conjugating hole of the blades, and wherein when the blades are struck by water flow in the water channel, the shaft, second gear, first gear would rotate accordingly to generate electricity.

9. A hydroelectric system comprising:
a water reservoir on the ground;
a water channel formed on at least one branch of the water reservoir, wherein the water channel has a top opening connected to an upper stream of the water reservoir and a lower opening connected to a lower stream of the water reservoir; and the water reservoir and water channel are located at substantially the same level; and
a plurality of power generating units spacedly disposed in the water channel, wherein each power generating unit has a power generator and a plurality of blades, and the blades are rotatable and secured at a base of said power generator.

10. The hydroelectric system of claim 9, wherein the water channel is spiral and a plurality of power generating units spacedly disposed therein to form a multi-layered power generating module.

11. The hydroelectric system of claim 9, wherein the power generator includes a main body, a first gear, a second gear, a shaft and a turbine; each main body connected to the first gear through a gear shaft and engaging with corresponding second gear; each shaft passing through corresponding second gear, turbine and a conjugating hole of the blades, and wherein when the blades are struck by water flow in the water channel, the shaft, second gear, first gear would rotate accordingly to generate electricity.

12. The hydroelectric system of claim 10, wherein the power generator includes a main body, a first gear, a second gear, a shaft and a turbine; each main body connected to the first gear through a gear shaft and engaging with corresponding second gear; each shaft passing through corresponding second gear, turbine and a conjugating hole of the blades, and wherein when the blades are struck by water flow in the water channel, the shaft, second gear, first gear would rotate accordingly to generate electricity.

13. The hydroelectric system of claim 12, wherein the water reservoir is a river, pond, lake, ocean and the like.

14. The hydroelectric system of claim 8, wherein the blades are detachable from the base of the power generator.

15. The hydroelectric system of claim 8, wherein the blade includes a curved first section and a curved second section to retain more water when being struck by the water flow to increase the torque of the blade and shaft.

16. The hydroelectric system of claim 12, wherein the blades are detachable from the base of the power generator.

17. The hydroelectric system of claim 12, wherein the blade includes a curved first section and a curved second section to retain more water when being struck by the water flow to increase the torque of the blade and shaft.

18. The hydroelectric system of claim 15, wherein angle of the curved first section of the blade is 29.09°, and the thickness of the blade is 178.882 mm.

19. The hydroelectric system of claim 17, wherein angle of the curved first section of the blade is 29.09°, and the thickness of the blade is 178.882 mm.
